(19) United States
(12) Patent Application Publication
(10) Pub. No.: US 2015/0208592 A1
(43) Pub. Date: Jul. 30, 2015

(54) PLANT-GROWING APPARATUS HAVING ROTATABLE MODULES

(71) Applicants: Edward J. Marchildon, Qualicum Bay (CA); Elizabeth A. Storey, Qualicum Bay (CA)

(72) Inventor: Edward J. Marchildon, Qualicum Bay (CA)

(73) Assignee: Elizabeth A. Storey, Qualicum Bay (CA)

(21) Appl. No.: 14/606,785

(22) Filed: Jan. 27, 2015

Related U.S. Application Data
(60) Provisional application No. 61/932,630, filed on Jan. 28, 2014.

(51) Int. Cl. A01G 9/02; A01G 27/00

(52) U.S. Cl. CPC A01G 9/02; A01G 27/00

(57) ABSTRACT

An apparatus (20) for growing plants comprises a bounded area (22) that holds a plurality of mobile carriers (24). Each carrier supports one or more rotatable plant-growing modules (26), with means for rotating the modules, and means for feeding water to plants in the modules. The module (26) comprises a cylindrical structure (54) for holding plants such that the plants grow radially inwardly toward a light source (62) inside the cylindrical structure. The bounded area has means for moving the mobile carriers, such that each mobile carrier is movable along a path within the bounded area.

### FIELD OF THE INVENTION

The invention pertains to apparatus for the large-scale production of plants using rotatable plant-growing modules.

### BACKGROUND OF THE INVENTION

It is known in the art of growing plants hydroponically to use a rotatable drum with an interior lamp, thereby providing for the efficient use of light. Marchildon, U.S. Pat. No. 6,604,321, discloses a rotary plant-growing apparatus with an open-ended cylindrical drum which rotates about a horizontal axis on a support stand. A lamp is positioned inside the drum. The drum holds plant containers, with the plants facing the light and the bottom of the containers extending radially outward from the drum. A trough of water under the drum is spaced from the drum such that the lower part of the containers contacts the water as the drum rotates, watering the plants. Marchildon, WO 2004/045273, discloses a plant-growing apparatus having a plurality of rotatable plant-growing modules which can be moved around a circuit in the apparatus. Each module comprises a cylindrical structure for holding plant-growing containers in which the plants grow radially inwardly towards a lamp. The modules are supported and rotated in a horizontal position as they are moved. Marchildon, WO 2013/044343, discloses a structure for growing plants comprising an array of containers, each of which holds a plurality of rotatable plant-growing modules.

The present invention is directed to improvements in systems for growing plants using multiple rotatable cylindrical structures arranged within a bounded area, for example a shipping container, whereby large numbers of plants can be grown hydroponically in a compact space and conveniently removed from the space for harvesting.

### SUMMARY OF THE INVENTION

The invention provides an apparatus for growing plants, comprising a bounded area that holds a plurality of mobile carriers, each of which supports one or more rotatable plant-growing modules, with means for rotating the modules, and means for feeding water to plants in the modules. The module comprises a cylindrical structure for holding plants such that the plants grow radially inwardly toward a light source inside the cylindrical structure. Optionally, the bounded area has means for moving the mobile carriers, such that each mobile carrier is movable along a path within the bounded area.

According to one aspect of the invention, the bounded area is a container having a floor, a top, a first end which is open or openable, a second end wall opposite to the first end, and two opposed side walls extending between the first end and the second end, and the path in the container is from the first end of the container to a place for removal of the mobile carrier from the container, for example a place at the second end or at the first end of the container.

These and other features of the invention will be apparent from the following description of specific embodiments, considered along with the accompanying drawings.

### BRIEF DESCRIPTION OF THE DRAWINGS

FIG. 1 is an isometric view, partly cutaway, of the plant-growing apparatus according to one embodiment of the invention.

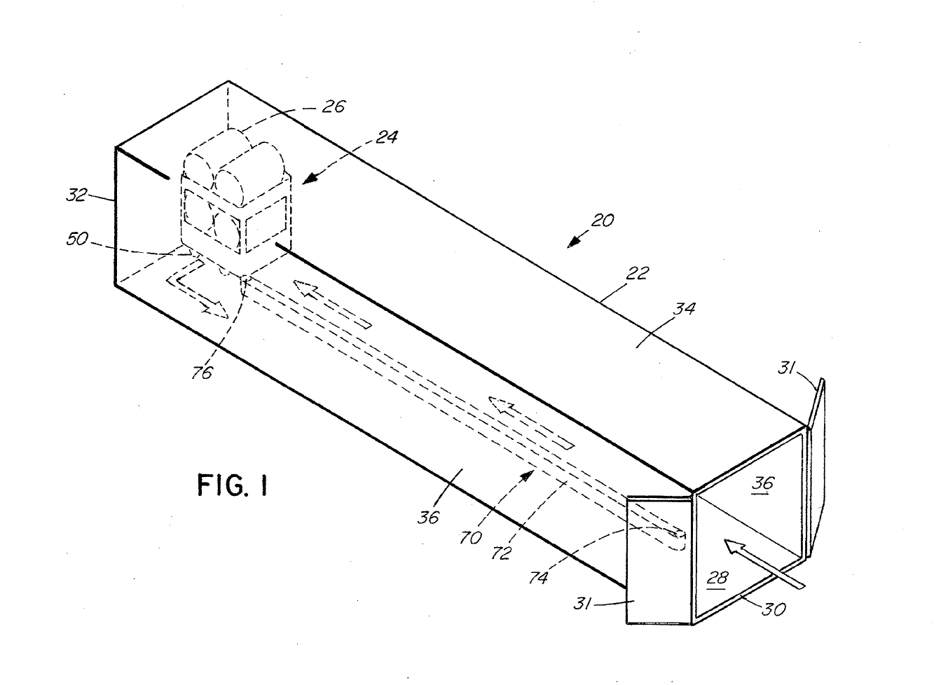

FIG. 2 is an isometric view of a mobile carrier supporting four rotatable modules.

### DETAILED DESCRIPTION OF THE PREFERRED EMBODIMENTS

The apparatus 20 for growing plants has a container 22 holding a plurality of mobile carriers 24, each of which supports a plurality of rotatable plant-growing modules 26. The container has a floor 28, an openable front end 30 with doors 31, a back end wall 32, a top 34 and two opposed side walls 36. An exemplary container size is 40 feet (12.192 m) long, 8 feet (2.438 m) wide, and 8.5 feet (2.591 m) high (external dimensions). In one embodiment, the container is a standard intermodal shipping container.

Each mobile carrier 24 is a box-like structure having two side walls 38, two end walls 40, a bottom wall 44, and a support frame 46 under the bottom wall with slots 48 configured to receive the forks of a forklift truck. The bottom has four casters 50. The top is open. Cutouts 52 in the side walls 38 and in the end walls 40 provide access to the interior of the mobile carrier 24 for the purpose of installation and servicing of the rotatable modules. An exemplary mobile carrier size is about 48 inches wide, 40 inches deep and 46 inches high. In some embodiments the mobile carrier has side and end walls that are supported, on their outer faces, by a grid of intersecting metal rods 49.

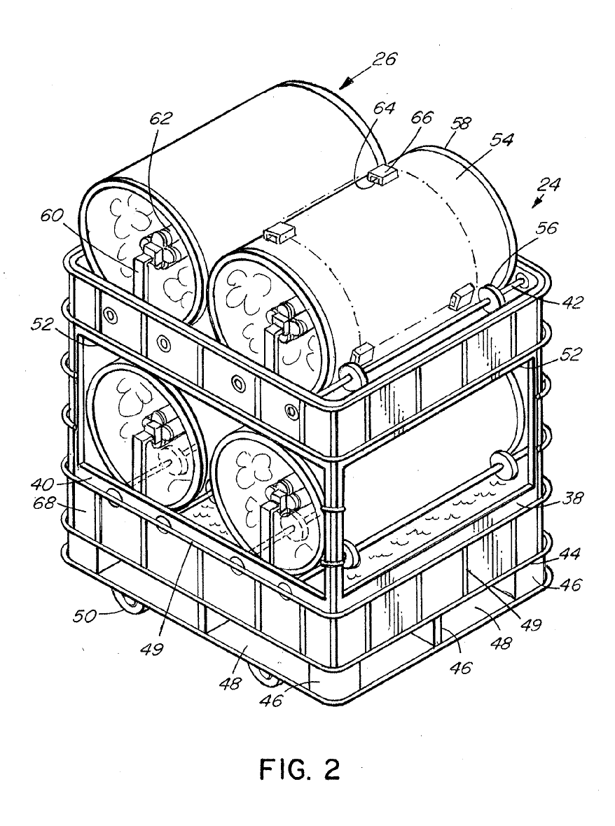

As seen in FIG. 2, a rotatable plant-growing module 26 comprises an open-ended cylindrical structure or drum, 54, which is rotatable on support wheels 56 that engage the cylindrical structure 54 adjacent to its rims 58. The wheels are held on rotatable rods 42, which are supported at their ends by bearings mounted in the end walls 40 of the mobile carrier. Drive means (not shown) on the mobile carrier comprise a motor and appropriate gear and control means to turn the rods 42 and support wheels 56. As the wheels 56 are turned, the cylindrical structure 54 is rotated about its longitudinal, horizontal axis. Lamp support members 60 are attached to the mobile carrier and hold a lamp 62 which extends longitudinally through each cylindrical structure in a generally axial position. The lamp provides illumination for the plants growing inside the module.

The cylindrical structure 54 has openings 64 which are adapted to receive and retain containers or trays 66 of growing medium in which plants can grow. For clarity of illustration, FIG. 2 shows only a few exemplary openings and trays, but it will be understood that there are many such openings and trays in each of the drums 54. Each module 26 is adapted to hold the plants so they can grow hydroponically (or aeroponically) and are oriented to grow radially inwardly of the cylindrical structure 54 towards the lamp 62, while their roots grow radially outwardly.

In some embodiments, the drum 54 may be substantially the same as the rotatable cylindrical drum disclosed in Marchildon, U.S. Pat. No. 6,604,321.

A mobile carrier 24 holds two rotatable modules 26 in its interior and supports two more rotatable modules above them, extending above the top edges of the side walls 38 and ends walls 40 such that each mobile carrier supports four rotatable modules. A single motor in the mobile carrier may be arranged with suitable belts or chains to drive the support wheels 56 of all four rotatable modules.

In some embodiments, the two upper rotatable modules are supported on the upper edges of a metal grid 49 enclosing the side walls and end walls of the mobile carrier. In other embodiments, the mobile carrier supports a single rotatable module 26.

Means are provided for conveying water and nutrients to the plants. In the illustrated embodiment of the apparatus, each mobile carrier has a water trough 68 and water-feeding means comprising a pump, conduits, and suitably positioned sprayers or injectors (not shown) for delivering water and nutrients from the trough 68 to the plant-growing medium in each module. In some embodiments the water troughs are also used to raise seafood, such as fish, lobsters, clams, etc.; waste materials produced by the seafood are used to fertilize the plants.

The mobile carriers 24 are movable on the floor 28 of the container 22 in order that they may be moved from the open end 30 of the container, where they are placed into it, toward the back end 32, and returned to the open end. Optionally, the mobile carriers are movable along a path extending from the front end 30 to the back end 32, then across the width of the container along the back end, and returning to the front end. For this purpose, a conveyor 70 is provided on the floor 28 of the container, along its center line. It comprises a conveyor belt 72 extending around two rollers 74, 76 which rotate about a vertical axis. One roller 74 is driven by a motor (not shown) and one or more intermediate rollers may be provided between the two end rollers 74, 76 to support the belt. In the illustrated embodiment, the internal width of the container 22 is equal to the width or depth of two mobile carriers 22 plus the width of the conveyor 70. Accordingly, two rows of mobile carriers fit in the container, separated by the conveyor. The conveyors 74, 76 are spaced from their respective adjacent front or back end 30, 32 of the container by a distance equal to the width or depth of a mobile carrier 24, such that the mobile carriers are movable transversely across the width of the container adjacent to both the back end and the front end. The belt 72 of the conveyor 70 engages a side wall of the mobile carrier, so a mobile carrier 24, placed in the container 22 at its open end, is thus movable by the conveyor 70, along one side of the container to its back end 32, across the width of the container to its opposite side, then along that side to the front end 30 of the container, and, optionally, across the width of the container adjacent to the front end, it its initial position. When multiple mobile carriers are present in the container, sufficient space is required for the transverse movement of the mobile carriers.

In other embodiments of the invention, the means for moving the mobile carriers within the container comprises pushing means such as pistons, mounted at suitable positions on the wall of the container, for pushing a mobile carrier or a row of the mobile carriers. Such pistons may be included in the illustrated embodiment to effect the transverse movement of the mobile carriers at the front and back ends of the container.

To service the modules, for example to do maintenance and repair, or to harvest the plants, the conveying means for moving the mobile carriers around the container is stopped when the mobile carrier to be serviced is in a position adjacent to the open end 30 of the container, at which point it can be removed from the container by a forklift truck, which can insert two lift arms into the slots 48 of the mobile carrier and lift it, with its set of rotatable modules, out of the container. The modules can then be removed from the mobile carrier for maintenance or replacement, or the plants can be harvested.

The mobile carriers 24 also include air pumps and conduits whereby air may be blown into each rotatable module, and means for providing electric power to the lamps 62 and to the motors for rotating the modules and for moving the mobile carriers within the container. The power for any of these may be provided by batteries. The apparatus 20 may include a power track mounted in the container for supplying electric power to the mobile carriers, or means for intermittently charging batteries in the mobile carriers. A power track may be positioned, for example, at the ceiling or floor of the container, to be contacted by a conductive member on the mobile carriers. The apparatus 20 also includes a controller (not shown) such as a PLC (programmable logic computer) to operate the apparatus, including the plant-growing modules, the air pumps and the water pumps, and means for charging the batteries. The modules may be tagged with radio-frequency identification (RFID) labels to facilitate automation of the operation of the structure. The apparatus 20 may include conventional means for controlling the temperature, humidity and air pressure inside the container, to optimize the growing conditions for the plants.

In this specification, where a component is referred to as a means, such reference should be interpreted as including as equivalents of that component any component which performs the same function as the described component.

As will be apparent to those skilled in the art in the light of the foregoing disclosure, many alterations and modifications are possible in the practice of the invention without departing from the scope thereof. For example, the container may be open or openable at both ends, so the mobile carriers can be placed into it at one end and removed at the other end. As another example, the bounded area does not need to be a container, but can be a defined floor area within a larger space. As another example, the means for moving the mobile carriers may comprise a chain drive that engages the underside of the mobile carriers. Accordingly, the scope of the invention is to be construed in accordance with the following claims.

1. An apparatus (20) for growing plants, comprising:
a bounded area (22),
the bounded area holding a plurality of mobile carriers (24) adapted for placement into, movement within, and removal from the bounded area, each mobile carrier supporting:
(i) one or more rotatable plant-growing modules (26), each module comprising a cylindrical structure (54) for holding plants such that the plants grow radially inwardly of the cylindrical structure toward a light source (62) inside the cylindrical structure;
(ii) means (56) for rotating the plant-growing modules; and
(iii) means (68) for feeding water to plants in the modules.

2. An apparatus according to claim 1, further comprising means (70) for moving the mobile carriers within the bounded area.

3. An apparatus according to claim 1, wherein the bounded area comprises a container (22) having a floor (28), a top (34), a first end (30), a second end (32) opposite the first end, and two opposed sides (36) extending between the first end and the second end.

4. An apparatus according to claim 3, wherein each mobile carrier is movable along a path from the first end (30) of the container and back to the first end (30) of the container for removal therefrom.

5. An apparatus according to claim 3, wherein the first end (30) of the container has one or more doors (31) for alternatively opening and closing the first end.

6. An apparatus according to claim 4, wherein the path forms a closed circuit and the mobile carriers are conveyable in a revolution around the circuit within the container.

7. An apparatus according to claim 1, wherein one or more of the plurality of rotatable plant-growing modules supported by a respective mobile carrier is inside the mobile carrier and one or more of the plurality of rotatable plant-growing modules is supported so as to extend above an upper edge of the respective mobile carrier.

8. An apparatus according to claim 1, wherein the mobile carriers have slots (48) therein configured to receive a lifting fork.

9. An apparatus according to claim 1, wherein the means for moving the mobile carriers comprises a conveyor (72, 74, 76) arranged to engage the mobile carriers.

10. An apparatus according to claim 2, wherein the means for moving the mobile carriers comprises a piston arranged to push the mobile carriers.

11. An apparatus according to claim 2, wherein the means for moving the mobile carriers further comprises casters (50) on the mobile carriers.

12. An apparatus according to claim 3, wherein the container (22) is an intermodal shipping container.

13. An apparatus for growing plants, comprising:
a container having a floor, a top, a first end with doors, a second end opposite the first end, and two opposed sides extending between the first end and the second end;
the container holding a plurality of mobile carriers having casters and adapted for placement into, movement within, and removal from the container, each mobile carrier supporting:
(i) one or more rotatable plant-growing modules, each module comprising a cylindrical structure for holding plants such that the plants grow radially inwardly of the cylindrical structure toward a light source inside the cylindrical structure;
(ii) means for rotating the plant-growing modules; and
(iii) means for feeding water to plants in the modules;
means for moving the mobile carriers within the container;
each mobile carrier being movable along a path from the first end of the container to the back end thereof and back to the first end of the container for removal therefrom.

14. An apparatus according to claim 1, further comprising means for providing electric power to the mobile carriers.

15. An apparatus according to claim 1, wherein the means for feeding water to plants comprises a water trough in the mobile carrier.

16. An apparatus according to claim 15, further comprising live seafood in the water trough.
